(19) United States
(12) Patent Application Publication
(10) Pub. No.: US 2008/0184685 A1
(43) Pub. Date: Aug. 7, 2008

(54) Frame and cassette filter

(75) Inventors: Jurgen Kempf, Viernheim (DE); Rainer Kaffenberger, Reichelsheim (DE)

Correspondence Address: GROSSMAN, TUCKER, PERREAULT & PFLEGER, PLLC, 55 SOUTH COMMERICAL STREET, MANCHESTER, NH, 03101, US

(73) Assignee: CARL FREUDENBERG KG, Weinheim (DE)

(21) Appl. No.: 12/024,747

(22) Filed: Feb. 1, 2008

(30) Foreign Application Priority Data
Feb. 2, 2007 (DE) 102007006103.1-27

(51) Int. Cl. B01D 29/05

(52) U.S. Cl. 55/497; 55/495

(57) ABSTRACT

With respect to the task of creating a frame for holding a filter element, the frame being easy to install following the inexpensive production thereof, a frame for receiving a filter element, comprising four wall elements (1, 2), which rest against one another on installation edges (3, 4) and form a peripheral wall (5), is characterized in that two wall elements (1, 2), respectively, are configured identically. Furthermore a cassette filter is provided.

### TECHNICAL FIELD

The invention relates to a frame for receiving a filter element, comprising four wall elements, which rest against one another on assembly edges and form a peripheral wall. The invention furthermore relates to a cassette filter comprising such a frame.

### STATE OF THE ART

Cassette filters of the type mentioned above are already known from the state of the art. For example, EP 1 414 547 B1 shows a cassette filter, which is made of a relatively high number of components.

The category-defining frames are rather expensive to produce because they comprise a plurality of individual components, which must be manufactured in a complex manner.

### DESCRIPTION OF THE INVENTION

It is therefore the object of the invention to create a frame for receiving a filter element, wherein the frame, following the inexpensive production thereof, is easy to install.

The above object is achieved according to the invention by a frame having the characteristics according to claim 1. According to the claim, two wall elements in each case are configured identically.

According to the invention, it was found that the provision of two identical wall elements considerably simplifies not only the production of the wall elements, but also the storage thereof. In particular, it was found that two identical wall elements, which are configured to complement two further identical wall elements at least in the region of the assembly edges, can be installed without difficulty since the use of further components for fixing the wall elements in place can be foregone. To this end, a frame is provided, which following the inexpensive production thereof is easy to install.

Consequently, the object mentioned above has been achieved.

On the assembly edges, means for fixing and connecting the wall elements may be configured. This concrete configuration makes it possible to produce a frame, which is made exclusively of four components, namely the wall elements. The means for fixing and connecting the wall elements may be integrated in the assembly edges, or formed thereon. This concrete configuration enables a compact design of the frame and a captive association of the means for fixing and connecting the wall elements.

On the assembly edges, means for latching the wall elements may be provided. Latching means enable a detachable connection of the wall elements. Furthermore, means for latching the wall elements enable fast fixation and connection of the wall elements.

By providing means for latching the wall elements, the frame can be installed particularly quickly.

Two wall elements, respectively, may comprise detent lugs, and two wall elements, respectively, may comprise holders for the detent lugs. The provision of detent lugs enables engagement in the holders and consequently a fixed connection of the wall elements to each other. The provision of detent lugs is furthermore advantageous because they can be deformed and bent relatively easily in order to detach the wall elements from one another or mount them to each other. Under these circumstances, it would be conceivable that detent lugs are provided, which have an opening in which an elevation of a wall element can engage. The opening may be configured in a circular manner, and the holder may be configured as a circular elevation which engages in the opening. This concrete embodiment is particularly advantageous with respect to production since round openings can be easily produced in an injection molding process.

The wall elements may be provided with insertion tapers. The provision of insertion tapers enables easy installation of the frame in a frame housing, particularly a filter housing. The frame can be inserted into a holder of a filter housing by means of the insertion tapers without tilting. These insertion tapers can be disposed on the wall elements such that they form a peripheral ramp or chamber.

The wall elements may be associated with reinforcing ribs. By providing reinforcing ribs, the wall thickness of the wall elements can be produced thinner. As a result, material savings can be achieved. Under these circumstances, it is conceivable that the reinforcing ribs face the inside of the frame. In this way, it is guaranteed that the outside wall of the frame is smooth. This embodiment enables nearly resistance-free insertion of the frame in a filter housing.

Installation handles may be disposed on at least two wall elements. The configuration of installation handles enables easy installation and removal of the frame into and from the filter housing since the installer can grasp and move the frame by the installation handles.

At least two wall elements could comprise retaining bars. The retaining bars prevent that polyurethane applied onto the wall elements can flow back out of the installed frame. In addition to polyurethane, further materials are conceivable, which can bond a filter element to the wall elements.

The wall elements could comprise strips protruding from the wall. This concrete embodiment enables a flange-like configuration of a head frame, which allows the frame to rest against the wall of a filter housing.

The strips could have smooth surfaces, on which seals are provided, which rest against the filter housing. The seals bring about a sealing contact of the frame with the filter housing. The seals could be molded onto the surfaces in order to enable fast production of the seals.

The strips could have a U-profile, be hollow, and comprise concave stabilizing bars. As a result of the hollow configuration, weight savings can be achieved. The provision of stabilizing bars prevents the strips from being compressed and damaged. The concave configuration of the stabilizing bars causes them to be offset inwardly. As a result of this concrete embodiment, an installer cannot be injured by the stabilizing bars. The risk for injury is furthermore prevented by the concave, namely flattened configuration of the bars. As a result of the offset of the stabilizing bars toward the inside, during installation of the frame it is almost impossible for screws, springs, or the like to strike against the stabilizing bars. This considerably facilitates the installation of the frame in the filter housing.

The strips could form a head frame. The head frame may bring about the contact of the frame in a filter housing.

The wall elements could be configured as injection-molded parts. This concrete embodiment enables a fast and cost-efficient production of the wall elements.

A cassette filter could comprise a frame, which is described here, and a filter element held by the frame. Such a cassette filter can be inserted in a filter housing in order to clean ambient air from airborne particles. In particular, it is conceivable to use the cassette filter as a fine mesh filter.

The cassette filter could comprise a pleated block made of filter paper pleated in zigzag shape, or non-woven material. The pleating increases the effective filter surface.

Various possibilities are available for advantageously configuring and further developing the teaching of the present invention. In this respect, reference is made on one hand to the patent claims and on the other hand to a preferred embodiment of the invention, which will be explained in more detail hereinafter with reference to the drawing.

Generally preferred embodiments and further developments of the method are also explained in conjunction with the explanation of the preferred embodiment of the invention with reference to the drawing.

### BRIEF DESCRIPTION OF THE DRAWING

The drawings show:

FIG. 1 a frame made of four wall elements,

FIG. 2 a wall element comprising a retaining bar, which is installed in the frame according to FIG. 1,

FIG. 3 a wall element comprising detent lugs, which is installed in the frame according to FIG. 1, and

FIG. 4 a view to explain a method for the production of a cassette filter.

### EXECUTION OF THE INVENTION

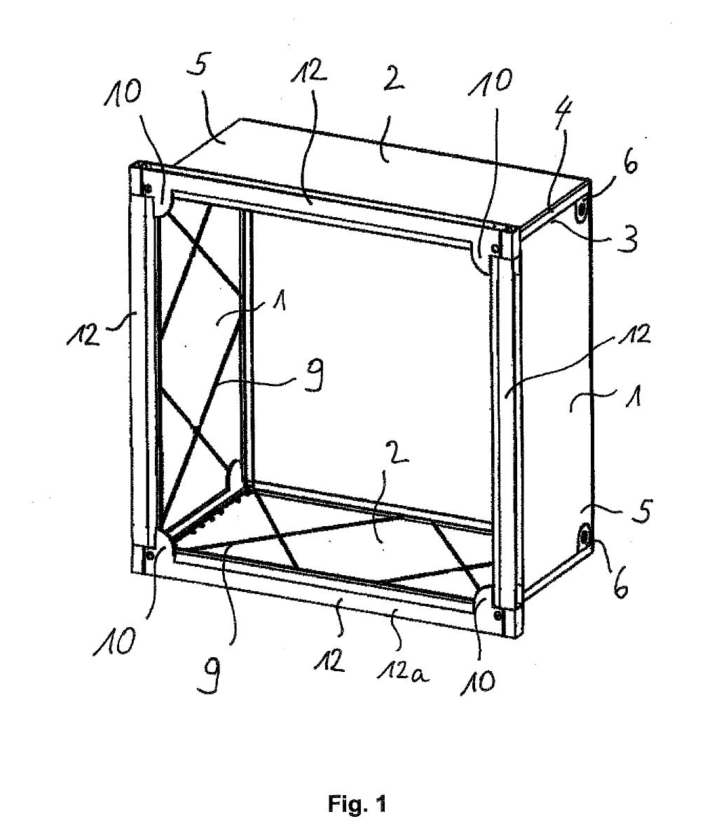

FIG. 1 shows a frame for receiving a filter element, comprising four wall elements 1, 2, which rest against one another on installation edges 3, 4, and form a peripheral wall 5. Two wall elements 1, 2 in each case are configured identically. in the region of the installation edges 3, 4, the wail elements 1, 2 are configured to complement one another and are connected to each other by snap-it.

On the installation edges 3, 4, means 6, 7 for fixing and connecting the wall elements 1, 2 are provided. Two wall elements 1, respectively, comprise detent lugs 6, and two wall elements 2, respectively, comprise holders 7 for the detent lugs.

The wall elements 1, 2 are associated with interior reinforcing ribs 9. In this way, it is ensured that the wall 5 facing toward the outside has a level design.

Installation handles 10, which serve the installation and removal of the frame into and from a filter housing, are disposed on at least two wall elements 1, 2.

The wall elements 1, 2 comprise strips 12 protruding from the wall 5. The strips 12 form a head frame, which has a flange-like design and allows the frame to rest against the wall of a filter housing 20, which is not shown.

The wall elements are configured as injection-molded parts. On the inside of the frame, a filter element 14, which is not shown, can be inserted.

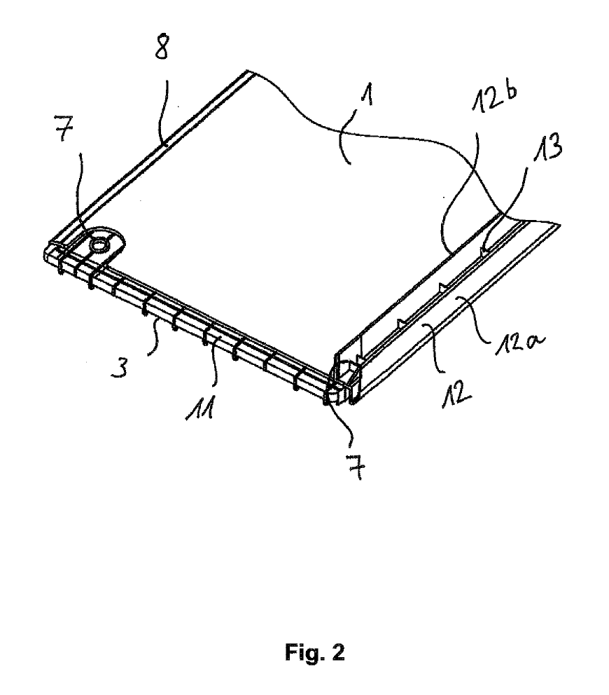

FIG. 2 shows one of the wall elements 1, which are installed in the frame according to FIG. 1. The wall element 1 comprises holders 7 for detent lugs, which are not shown. On the wall element 1, an insertion taper 8 is provided, which forms a peripheral ramp together with the other wall elements 1, 2.

The wall element 1 comprises a retaining bar 11, which prevents polyurethane from flowing out of the frame in the installed state.

The wall element 1 has a strip 12 with a U-profile, the strip protruding from the wall 5. The strip.12 is configured to be hollow and comprises concave, inwardly offset stabilizing bars 13. These stabilizing bars 13 prevent the strip 12 from being compressed. The wall element 1 is configured as an injection-molded part.

On the level surfaces 12a and 12b of the strip 12, seals may be provided. The seals can be molded on. Surface 12b is disposed opposite from surface 12a.

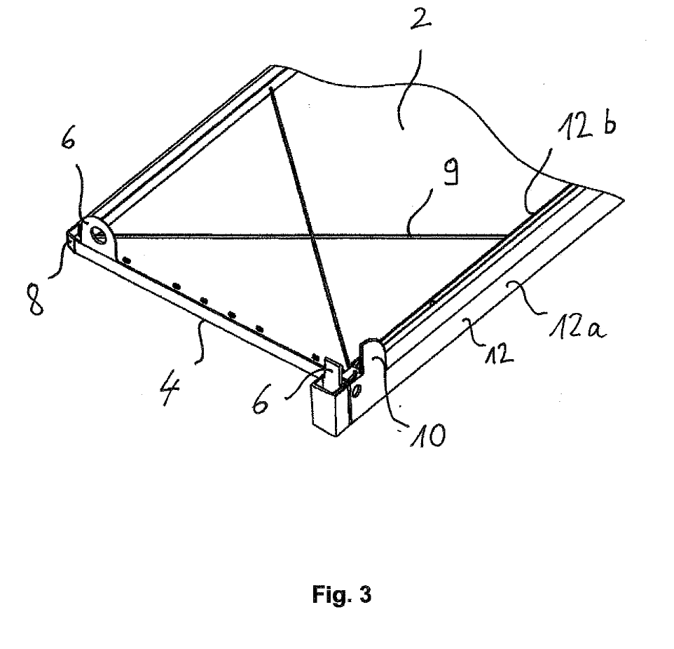

FIG. 3 shows one of the wall elements 2, which are installed in the frame according to FIG. 1. The wall element 2 comprises detent lugs 6, which can engage in the holders 7 of a wall element 1. One of the detent lugs 6 comprises a round opening into which a round elevation 7 of the wall element 1 according to FIG. 2 can engage. A further detent lug 6 is configured as a detent hook, which can interlock with a bar in the wall element 1, wherein the cross-member is not shown.

On the wall element 2, an insertion taper 8 is provided, which forms a peripheral ramp together with the insertion tapers 8 of the wall elements 1, 2. The wall element 2 comprises reinforcing ribs 9. The wall element according to FIG. 2 is also associated with reinforcing ribs 9, however these are not visible, because FIG. 2 also illustrates the level wall of the wall element 1.

The wall element 2 comprises two installation handles 10, which have a quarter-circle shaped design. In the latched state, the quarter-circle shaped installation handle 10 forms a rounded corner region of the frame. The wall element 2 has a strip 12 protruding from the wall 5, wherein the strip can form a head frame. The wall element 2 is configured as an injection-molded part.

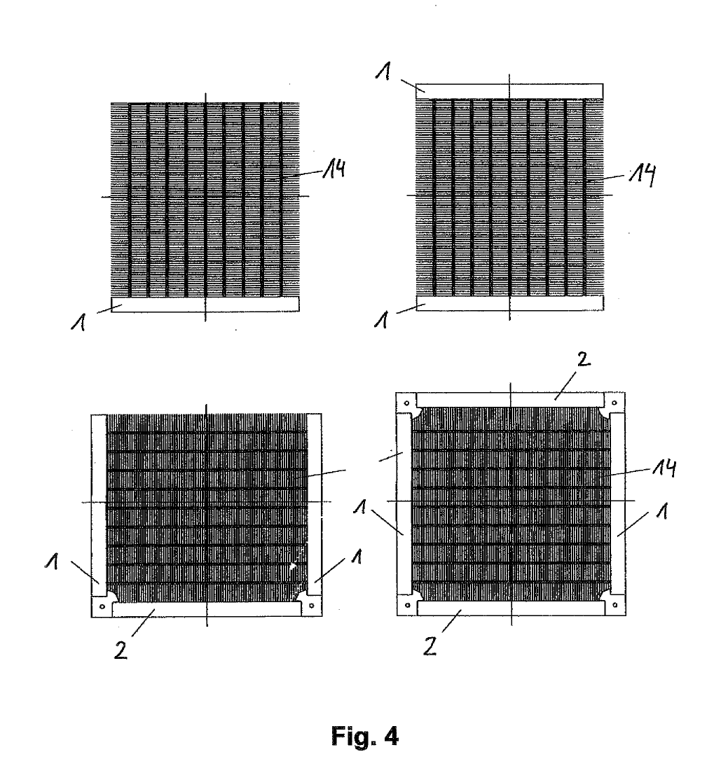

FIG. 4 shows the individual manufacturing steps for producing a cassette filter comprising a filter element 14 in an illustrative view.

The method comprises the following manufacturing steps:

Providing a wall element 1 and filling the inner wall thereof with polyurethane. Placing the filter element 14 onto the wall element 1. Placing a further wall element 1 onto the filter element 14, wherein the further wall element 1 is likewise filled with polyurethane. The wall elements 1 disposed on the filter element 14 are latched into a wall element 2, which is likewise filled with polyurethane. Finally, a further wall element 2 is latched to the wall elements 1. The last wall element 2 is also filled with polyurethane.

The method described here allows the production of a cassette filter, which comprises a frame described here and a filter element 14 held by the frame.

With respect to further advantageous embodiments and further developments of the teaching according to the invention, reference is made on the one hand to the general part of the description and on the other hand to the attached claims.

Finally, it shall be expressly noted that the above arbitrarily selected exemplary embodiment only serves the explanation of the inventive teaching, however it does not limit it to these exemplary embodiments.

What is claimed is:

1. A frame for receiving a filter element, comprising four wall elements, which rest against one another on installation edges and form a peripheral wall, characterized in that two wall elements, respectively, are configured identically.

2. The frame according to claim 1, characterized in that on the installation edges means for fixing and connecting the wall elements, are configured.

3. The frame according to claim 1, characterized in that on the installation edges, means for latching the wall elements, are configured.

4. The frame according to claim 2, characterized in that two wall elements, respectively, comprise detent lugs, and two wall elements, respectively, comprise holders for the detent lugs.

5. A frame according to claim 1, characterized in that insertion tapers are provided on the wall elements.

6. A frame according to claim 1, characterized in that reinforcing ribs are associated with the wall elements.

7. A frame according to claim 1, characterized in that installation handles are disposed on at least two wall elements.

8. A frame according to claim 1, characterized in that retaining bars are provided on at least two wall elements.

9. A frame according to claim 1, characterized in that the wall elements comprise strips protruding from the wall.

10. The frame according to claim 9, characterized in that the strips have a U-profile, are hollow, and comprise concave stabilizing bars.

11. The frame according to claim 9, characterized in that the strips form a head frame.

12. A frame according to claim 1, characterized in that the wall elements are configured as injection-molded parts.

13. A cassette filter, comprising a frame according to claim 1 and a filter element held by the frame.
